(19) United States
(12) Patent Application Publication
(10) Pub. No.: US 2014/0034636 A1
(43) Pub. Date: Feb. 6, 2014

(54) MICROWAVE IRRADIATION APPARATUS

(71) Applicant: TOKYO ELECTRON LIMITED, Minato-ku (JP)

(72) Inventors: Nobuhiko YAMAMOTO, Yamanashi (JP); Junichi Kitagawa, Yamanashi (JP); Sumi Tanaka, Yamanashi (JP); Yuki Osada, Yamanashi (JP)

(73) Assignee: TOKYO ELECTRON LIMITED, Minato-ku (JP)

(21) Appl. No.: 13/948,436

(22) Filed: Jul. 23, 2013

(30) Foreign Application Priority Data
Aug. 1, 2012 (JP) 2012-171265

(51) Int. Cl. H05B 6/64

(52) U.S. Cl. CPC H05B 6/6402
USPC 219/756

(57) ABSTRACT

A microwave irradiation apparatus, for performing a predetermined process by irradiating a microwave to a target substrate, includes a processing chamber configured to accommodate the target substrate, a support member configured to support the target substrate in the processing chamber, and a microwave introduction mechanism configured to generate microwaves and introduce the microwaves into the processing chamber. The microwave irradiation apparatus further includes microwave introduction ports through which the microwave generated by the microwave introducing mechanism is introduced into the processing chamber, electric field sensors configured to measure an electric field formed by the microwave introduced into the processing chamber, and a control unit configured to control powers of the microwaves introduced into the processing chamber through the microwave introduction ports from the microwave introduction mechanism based on the electric field measured by the electric field sensors.

### CROSS-REFERENCE TO RELATED APPLICATION

This application claims priority to Japanese Patent Application No. 2012-171265 filed on Aug. 1, 2012, the entire contents of which are incorporated herein by reference.

### FIELD OF THE INVENTION

The present invention relates to a microwave irradiation apparatus which performs processing such as modification or heating by irradiating a microwave on a target object.

### BACKGROUND OF THE INVENTION

In a manufacturing process of a semiconductor device, there is a step of forming an impurity diffusion layer by performing impurity activation annealing after implanting impurities into a semiconductor substrate. Conventionally, in the activation treatment of impurities, heat treatment is performed at a high temperature of 1000° C. or more for a short period of time by lamp annealing. However, in recent years, with the miniaturization of the design rule of the semiconductor device, annealing techniques to suppress the thermal diffusion of impurities have been demanded, and lower temperature annealing techniques have been studied. For annealing at low temperatures, annealing by microwave irradiation has been proposed (see, e.g., Japanese Patent Application Publication No. 2009-516375). Further, a modification process of a gate insulating film by microwave irradiation has also been studied.

In a microwave irradiation apparatus used for such applications, performing open loop control for defining a process with only the processing time and the set microwave power, or controlling the microwave power by feeding back the temperature is generally performed.

However, in the open-loop control, there is a stability problem during mass production. On the other hand, when controlling the microwave power by feeding back the temperature, process reproducibility is not sufficient.

### SUMMARY OF THE INVENTION

In view of the above, the present invention provides a microwave irradiation apparatus capable of performing high stability processing during mass production and high process reproducibility.

In accordance with an aspect of the present invention, there is provided a microwave irradiation apparatus for performing a predetermined process by irradiating a microwave to a target substrate, the microwave irradiation apparatus including: a processing chamber configured to accommodate the target substrate; a support member configured to support the target substrate in the processing chamber; a microwave introduction mechanism configured to generate microwaves and introduce the microwaves into the processing chamber; one or more microwave introduction ports through which the microwave generated by the microwave introducing mechanism is introduced into the processing chamber; one or more electric field sensors configured to measure an electric field formed by the microwave introduced into the processing chamber; and a control unit configured to control powers of the microwaves introduced into the processing chamber through the microwave introduction ports from the microwave introduction mechanism based on the electric field measured by the electric field sensors.

### BRIEF DESCRIPTION OF THE DRAWINGS

The objects and features of the present invention will become apparent from the following description of embodiments, given in conjunction with the accompanying drawings, in which:

FIG. 1 is a cross-sectional view showing a schematic configuration of a microwave irradiation apparatus in accordance with an embodiment of the present invention;

FIG. 2 is a block diagram showing a schematic configuration of a high voltage power supply unit in the microwave irradiation apparatus of FIG. 1;

FIG. 3 is a diagram for explaining an arrangement example of an electric field sensor in an electric field monitoring unit;

FIG. 4 is a cross-sectional view showing a configuration of the electric field sensor in the electric field monitoring unit;

FIG. 5 is a block diagram showing a configuration of a control unit in the microwave irradiation apparatus or FIG. 1;

FIG. 6 is a diagram for explaining a shape of the microwave introduction port;

FIGS. 7A and 7B are views schematically showing electromagnetic field vectors of the microwave emitted from the microwave introduction port;

FIG. 8 is a bottom view of the top wall showing a first arrangement example of the microwave introduction ports;

FIG. 9 is a bottom view of the top wall showing a second arrangement example of the microwave introduction ports;

FIG. 10 is a bottom view of the top wall showing a third arrangement example of the microwave introduction ports;

FIGS. 11A and 11B are diagrams showing the results of obtaining the variation in the resistance of the wafer in the radial direction for a temperature rising region (FIG. 11A) and a saturation region (FIG. 11B) when it is subjected to activation treatment by irradiating the microwave to the wafer to optimize the microwave power in a case where the microwave introduction ports are uniformly arranged and a case where the microwave introduction ports are arranged in two zones; and

FIGS. 12A and 12B are diagrams showing the results of obtaining the variation in the resistance of the wafer in the radial direction for a temperature rising region (FIG. 12A) and a saturation region (FIG. 12B) when it is subjected to activation treatment by irradiating the microwaves to the wafer while varying the power ratio of the microwave between the inner area and the outer area when the microwave introduction ports are arranged in two zones.

### DETAILED DESCRIPTION OF THE EMBODIMENTS

Hereinafter, an embodiment of the present invention will be described in detail with reference to the accompanying drawings.

As a microwave irradiation apparatus, an apparatus for performing annealing or modification treatment on a semiconductor wafer such as a silicon wafer (hereinafter, simply referred to as “wafer”) by microwave irradiation will be described. In this process, for example, impurity activation annealing performed after implanting impurities in the source and drain, or modification treatment of a high dielectric constant (High-k) material film used for a gate insulating film may be mentioned.

<Configuration of Microwave Irradiation Apparatus>

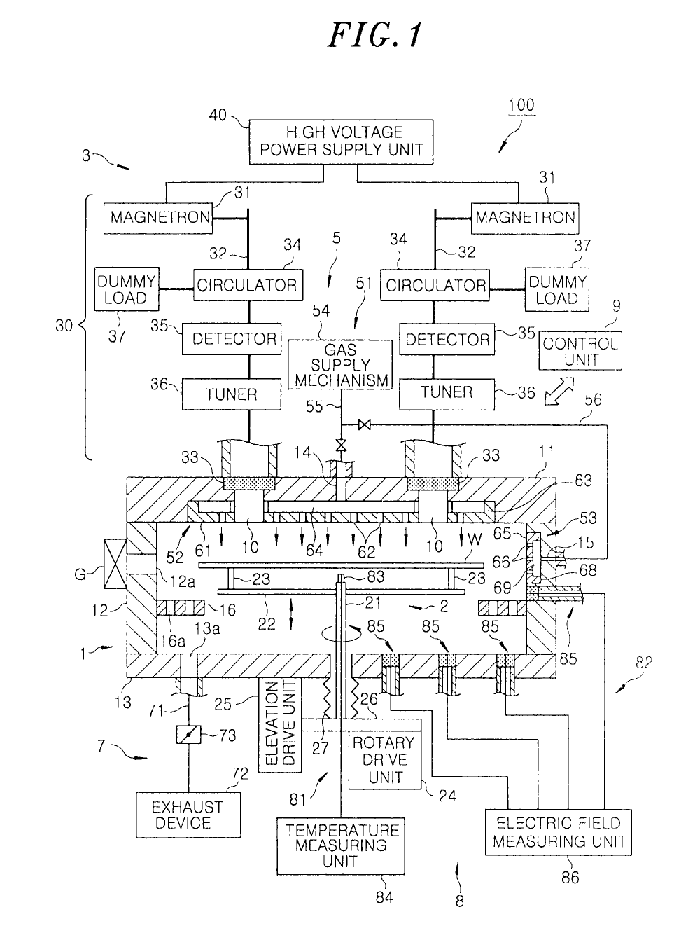

FIG. 1 is a cross-sectional view showing a schematic configuration of a microwave irradiation apparatus according to an exemplary embodiment of the present invention.

A microwave irradiation apparatus 100 includes a processing chamber 1 for accommodating the wafer W serving as a substrate to be processed, a support part 2 for supporting the wafer W in the processing chamber 1, a microwave introduction mechanism 3 for introducing microwaves into the processing chamber 1, a gas inlet part b for introducing a gas into the processing chamber 1, an exhaust system 7 for evacuating the processing chamber 1, a monitoring part 8 for monitoring the temperature or electric field, and a control unit 9 for controlling the respective components.

The processing chamber 1 is formed of a metal material, e.g., aluminum, aluminum alloy, stainless steel, or the like. The processing chamber 1 has sidewalls 12 forming a square tube, a top wall 11 closing an upper opening of the sidewalls 12, and a bottom wall 13 closing a lower opening of the sidewall 12. A plurality of (four in this embodiment, only two of which are shown in FIG. 1) microwave introduction ports 10 are provided in the top wall 11 to vertically extend through the top wall 11, and the top wall 11 includes an upper shower mechanism 52 therein. A transfer port 12a for loading/unloading the wafer W between the processing chamber and a transfer chamber (not shown) is provided in one of the sidewalls 12, and an exhaust port 13a is provided in the bottom wall 13. The inner surfaces of the sidewalls 12 is formed to be flat and functions as a reflecting surface for reflecting the microwaves. The transfer port 12a is intended to perform loading and unloading of the wafer W between the processing chamber 1 and the transfer chamber (not shown) adjacent to the processing chamber 1. The transfer port 12a is opened and closed by a gate valve G. The processing chamber hermetically sealed by keeping the gate valve G in a closed state, and the transfer of the wafer W between the processing chamber 1 and the transfer chamber is allowed by keeping the gate valve G in an open state. Further, a rectifying plate 16 forming a frame shape is provided in an outer peripheral portion near the bottom of the processing chamber 1. Rectifier holes 16a are formed in the rectifying plate 16 to vertically extend therethrough. The rectifying plate 16 is formed of a metal material such as aluminum, aluminum alloy, and stainless steel.

The support part 2 includes a tubular shaft 21 extending to the outside of the processing chamber 1 while passing substantially through the center of the bottom wall 13 of the processing chamber 1, a plurality of (e.g., three) arm portions 22 extending substantially horizontally from a leading end portion of the shaft 21, support pins 23 detachably attached to the arm portions 22 to support the wafer W, a rotary drive unit 24 for rotating the shaft 21, an elevation drive unit 25 for vertically moving the shaft 21, and a movable connecting portion 26 for connecting the rotary drive unit 24 to the elevation drive unit 25 while supporting the shaft 21. The rotary drive unit 24, the elevation drive unit 25, and the movable connecting portion 26 are provided outside the processing chamber 1. A bellows 27 is provided around a portion where the shaft 21 passes through the bottom wall 13 of the processing chamber 1. The bellows 27 may not be provided if the pressure in the processing chamber 1 approximates an atmospheric pressure, and the leakage of the gas supplied is acceptable.

In the support part 2, the shaft 21, the arm portions 22, the rotary drive unit 24, and the movable connecting portion 26 constitute a rotation mechanism for rotating the wafer W supported by the support pins 23 in a horizontal plane. The support pins 23 support the wafer w by making contact with the backside of the wafer W in the processing chamber 1. By driving the rotary drive unit 24, the arm portions 22 are rotated around the shaft 21 to rotate the wafer W supported by the support pins 23. Further, the shaft 21 is moved up and down by driving the elevation drive unit 25. The support pins 23 and the arm portions 22 are formed of a dielectric material such as quartz, ceramic, or the like.

Further, the rotary drive unit 24 is not particularly limited as long as it can rotate the shaft 21, and for example, a motor can be used. Further, the elevation drive unit 25 is not particularly limited as long as it can rotate the shaft 21 and the movable connecting portion 26, and for example, a cylinder mechanism or a ball screw can be used. Further, the rotary drive unit 24 and the elevation drive unit 25 may be integrated with each other.

The microwave introduction mechanism 3 is provided above the processing chamber 1 and functions as a microwave introducing unit for introducing an electromagnetic wave (microwave) into the processing chamber 1. As shown in FIG. 1, the microwave introduction mechanism 3 includes microwave units 30 for introducing a microwave into the processing chamber 1 and a high voltage power supply unit 40 connected to the microwave units 30.

In this embodiment, all the microwave units 30 have the same configuration. Each of the microwave units 30 has a magnetron 31 as a microwave source, which generates a microwave for processing the wafer W, and a waveguide 32, which transmits the microwave generated in the magnetron 31 to the processing chamber 1. The waveguide 32 is connected to the microwave introduction ports 10 provided in the top wall 11 of the processing chamber 1. In each of the microwave introduction ports 10, a transmission window 33 for blocking the inlet thereof is fitted to the top wall 11.

The magnetron 31 has anode and cathode (both not shown) to which a high voltage supplied by the high voltage power supply unit 40 is applied. Further, as the magnetron 31, it is possible to use one which can oscillate microwaves of different frequencies. The magnetron 31 can generate a microwave of a frequency optimal for each process. For example, in the annealing treatment, a microwave of a high frequency such as 2.45 GHz and 5.8 GHz is preferable, and a microwave of 5.8 GHz is particularly preferable.

The waveguide 32 has a rectangular tube shape, and extends upwardly from a portion corresponding to the transmission window 33 fitted to each of the microwave introduction ports 10 on the upper surface of the top wall 11 of the processing chamber 1. The magnetron 31 is connected to an upper end portion of the waveguide 32. The microwave generated in the magnetron 31 is introduced into the processing chamber 1 through the waveguide 32 and the transmission window 33.

The transmission window 33 is formed of a dielectric material. As the material of the transmission window 33, for example, quartz, ceramic, or the like may be used. A gap between the transmission window 33 and the top wall 11 is hermetically sealed by a sealing member (not shown). From the viewpoint of preventing the microwave from being radiated directly to the wafer W, a distance from the bottom surface of the transmission window 33 to the top surface of the wafer W supported by the support pins 23 is preferably, e.g., 25 mm or more, and more preferably adjusted in a range from 25 to 50 mm.

The microwave unit 30 further includes a circulator 31, a detector 35, and a tuner 36 provided on the waveguide 32, and they are provided in this order from the upper end portion of the waveguide 32. Further, a dummy load 37 is connected to the circulator 34. The circulator 34 and the dummy load 37 constitute an isolator for separating the reflected wave from the processing chamber 1. That is, the circulator 34 leads the reflected wave from the processing chamber 1 to the dummy load 37, and the dummy load 37 converts the reflected wave led by the circulator 34 into heat.

The detector 35 serves to detect the reflected wave from the processing chamber 1 in the waveguide 32. The detector 35 includes, e.g., an impedance monitor, specifically, a standing wave monitor for detecting an electric field of a standing wave in the waveguide 32. The standing wave monitor may include three pins protruding into an interior space of the waveguide 32. By detecting the location, phase, and intensity of the standing wave by the standing wave monitor, it is possible to detect the reflected wave from the processing chamber 1. Further, the detector 35 may be constituted by a directional coupler capable of detecting the reflected wave and the traveling wave.

The tuner 36 has a function of performing impedance

matching between the processing chamber 1 and the magnetron 31. The impedance matching using the tuner 36 is performed based on a detection result of the reflected wave at the detector 35. For example, the tuner 36 may include a conductive plate (not shown) provided to protrude into and retreat from the interior space of the waveguide 32, and the tuner 36 can perform impedance matching between the processing chamber 1 and the magnetron 31 by adjusting the amount of power of the reflected wave by controlling the protruding amount of the conductive plate 32 into the interior space of the waveguide 32.

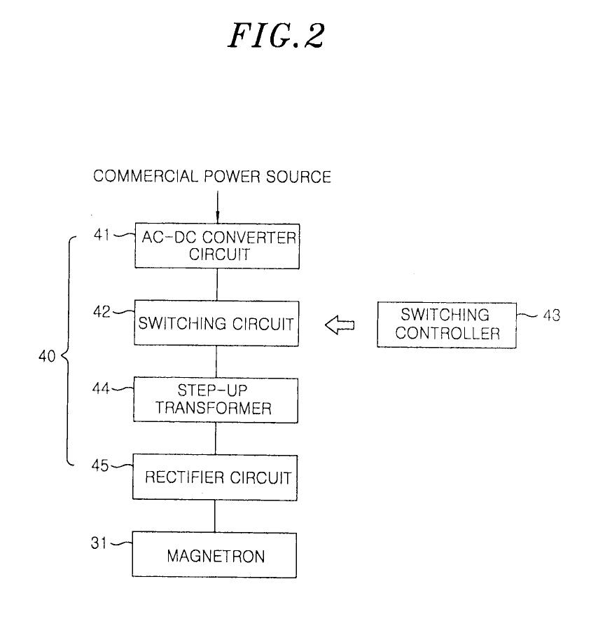

The high voltage power supply unit 40 supplies a high voltage for generating a microwave for the magnetron 31. The high voltage power supply unit 40 includes, as shown in FIG. 2, an AC-DC converter circuit 41 connected to a commercial power source, a switching circuit 42 connected to the AC-DC converter circuit 41, a switching controller 43 which controls the operation of the switching circuit 42, a step-up transformer 44 connected to the switching circuit 42, and a rectifier circuit 45 connected to the step-up transformer 44. The magnetron 3 1 is connected to the step up transformer 44 via the rectifier circuit 45.

The AC-DC converter circuit 41 is a circuit which rectifies an alternating current (e.g., three-phase 200V AC) from a commercial power supply and converts it into a direct current of a predetermined waveform. The switching circuit 42 is a circuit for controlling ON and OFF of the direct current which is converted by the AC-DC converter circuit 41. In the switching circuit 42, phase-shifted PWM (Pulse Width Modulation) control or PAM (Pulse Amplitude Modulation) control is performed by the switching controller 43, thereby generating a pulsed voltage waveform. The step-up transformer 44 boosts the voltage waveform outputted from the switching circuit 42 to a predetermined magnitude. The rectifier circuit 45 is a circuit which rectifies the voltage boosted by the step-up transformer 44 and supplies the rectified voltage to the magnetron 31.

The gas inlet part 5 includes a gas supply unit 51, an upper shower mechanism 52, and a side shower mechanism 53.

The gas supply unit 51 includes a gas supply mechanism 54 having a gas supply source, a gas pipe, a valve system, a flow rate controller, and the like; and gas supply pipes 55 and 56 for supplying a gas from the gas supply mechanism 54 to the upper shower mechanism 52 and the side shower mechanism 53, respectively. The gas supply pipe 55 is connected to a gas inlet 14 provided at the center of the top wall 11 of the processing chamber 1. Further, the gas supply pipe 56 is connected to a gas inlet 15 provided at a position opposite to the transfer port 12a of the sidewall of the processing chamber 1.

The upper shower mechanism 52 includes a disc-shaped main body 61 which is fitted and fixed in a recess formed on the lower surface of the top wall 11 of the processing chamber 1. The main body 61 is provided so as to correspond to the wafer W which is supported by the support pins 23, and gas holes (orifices) 62 are formed in the surface thereof. Further, a rib 63 is formed on the periphery of the upper portion of the main body 61, and the rib 63 is in contact with the lower surface of the top wall 11 to define a gas diffusion space 64 between the upper surface of the main body 61 and the lower surface of the top wall 11. Thus, a gas supplied from the gas supply unit 51 is diffused in the space 64 through the gas inlet 14 and injected toward the wafer W through the gas holes 62.

The side shower mechanism 53 is formed on one of the sidewalls 12 of the processing chamber 1 which is opposite to the transfer port 12a, and includes a rectangular main body 65 which is fitted and fixed in a recess formed on the inner surface of the corresponding sidewall 12. The main body 65 is provided so as to face the transfer port 12a, and gas holes 66 are formed on the surface thereof. Further, a rib 68 is formed in a peripheral portion of the surface opposite to a gas injection surface of the main body 65. When the main body 65 is fitted to the corresponding sidewall 12, a space 69 is defined between the main body 65 and the corresponding sidewall 12 by the presence of the rib 68. The gas inlet 15 provided in the corresponding sidewall 12 communicates with the space 69, and the gas supplied from the gas supply unit 51 is diffused in the space 69 through the gas inlet 15, and is injected along the horizontal direction into the processing chamber 1 through the gas holes 66.

In the gas inlet part 5, the gas from the gas supply unit 51 is introduced into the processing chamber 1 through the upper shower mechanism 52 and the side shower mechanism 53. However, as the gas to be introduced, a gas for forming an atmosphere in the processing chamber 1, a cooling gas for cooling the wafer W and a purge gas for purging the inside of the processing chamber 1 are used. Further, depending on a type of the process, a processing gas for performing a specific process may be used. All the gases injected from the upper shower mechanism 52 and the side shower mechanism 53 may function as a gas for forming an atmosphere, a cooling gas, a purge gas, and a processing gas. Since the gas injected from the upper shower mechanism 52 can be in direct contact with the wafer W, it is suitable for cooling the wafer W. Since the gas injected from the side shower mechanism 53 is supplied toward the transfer port 12a, it is suitable for suppressing ambient air containing oxygen from entering the processing chamber 1 during opening of the gate valve G. As the gas supplied from the gas supply part 5, for example, N₂ gas, Ar gas, He gas, Ne gas, O₂ gas, and H₂ gas can be used.

The exhaust system 7 includes an exhaust pipe 71 connected to the exhaust port 13a, an exhaust device 72 having a vacuum pump such as a dry pump provided in the exhaust pipe 71, and a pressure control valve 73 provided in the exhaust pipe 71. The processing chamber 1 is evacuated by the exhaust system 7. Further, the microwave irradiation apparatus 100 can also perform processing at an atmospheric pressure. In this case, the exhaust device 72 can have a simple structure such as a fan for exhausting the inside of the processing chamber 1 to achieve gas replacement instead of the vacuum pump. Further, it is also possible to use exhaust equipment provided in facilities where the microwave irradiation apparatus 100 is installed.

The monitoring part 8 has a temperature monitoring unit 81 which monitors the temperature of the processing chamber 1, and an electric field monitoring unit 82 which monitors the electric field in the processing chamber 1.

The temperature monitoring unit 81 includes radiation thermometers 83 for measuring the surface temperature of the wafer W, and a temperature measuring portion 84 connected to the radiation thermometers 83. Further, in FIG. 1, for convenience, only the radiation thermometer 83 for measuring the surface temperature of a central portion of the wafer W is illustrated.

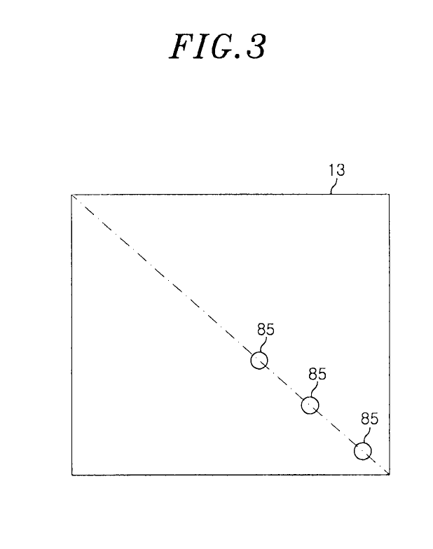

The electric field monitoring unit 82 includes electric field sensors 85 for detecting an electric field (i.e., the intensity of microwaves) formed in the processing chamber 1 by introducing microwaves into the processing chamber 1, and an electric field measuring unit 86 connected to the electric field sensors 85. As the electric field sensors 85, for example, as shown in FIG. 1, three electric field sensors are provided to face the inside of the processing chamber 1 from the bottom wall 13 of the processing chamber 1, and one electric field sensor is provided to face the inside of the processing chamber 1 from the middle height position of one of the sidewalls 12. For example, as shown in FIG. 3, the electric field sensors 35 of the bottom wall 13 are respectively provided at central, outer, and intermediate portions along a diagonal line on the bottom wall 13. Further, the number and positions of the electric field sensors 85 are not limited thereto, and one electric field sensor may be provided.

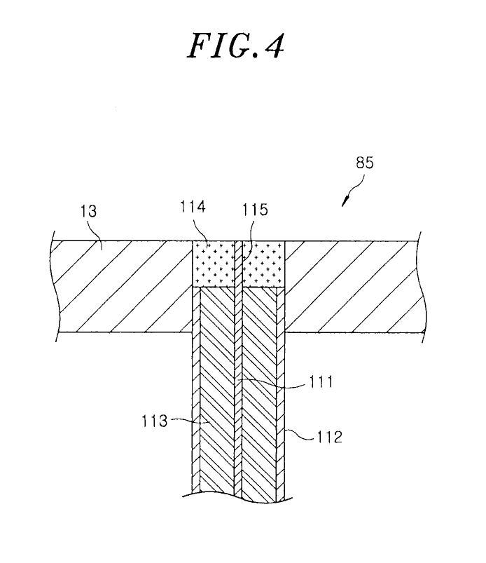

Each of the electric field sensors 85 is formed in a coaxial cable shape, and a monopole antenna is provided as the tip thereof. Specifically, as shown in FIG. 4, the electric field sensor 85 includes an inner conductor 111, an outer conductor 112 provided outside the inner conductor 111, and a dielectric material 113 of Teflon (registered trademark) or the like provided therebetween. At a portion between the leading end of the electric field sensor 85 and a position apart from the leading end by about 3 mm, the outer conductor 112 and the dielectric material 113 do not exist, and a leading end portion 115 of the inner conductor 111 is embedded in a dielectric member 114 located on the inner surface of the bottom wall 13 (or the sidewall 12) to form a monopole antenna. Thus, the electromagnetic wave (microwave) in the processing chamber 1 is inputted through the leading end portion 115, and a signal can be extracted. The extracted signal is measured by the electric field measuring unit 86. In this case, since the current flowing through the lines of the electric field sensors 85 is proportional to the electric field, the electric field may be monitored by the electric field sensors 85. Then, since the square of the value of the monitored electric field is proportional to the introduced microwave power, it is possible to control the microwave power introduced from the microwave introduction mechanism 3 based on the value of the monitored electric field.

As the electric field sensor 85, a coaxial cable of a standard product (inner conductor: φ 0.51 mm, outer conductor: φ 2.19 mm, dielectric: φ 1.67 mm) can be used.

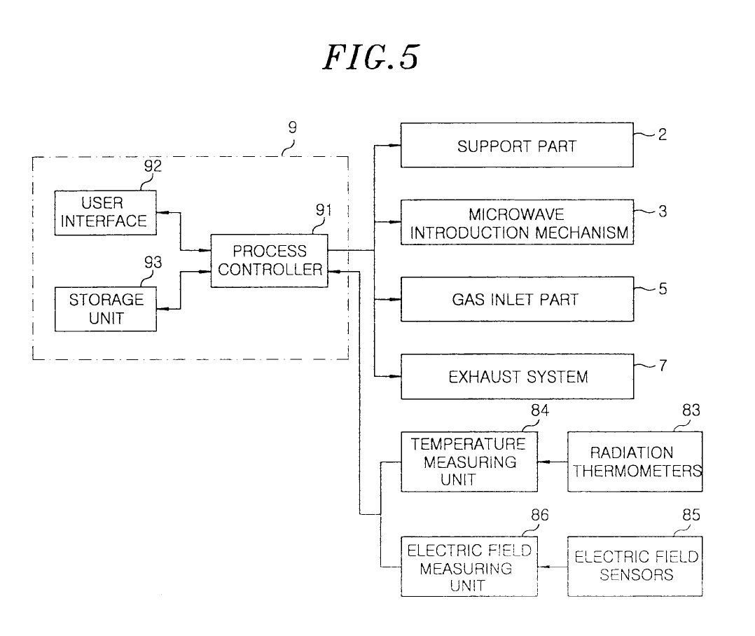

The control unit 9 controls the respective components of the microwave irradiation apparatus 100, and typically includes a computer. As shown in FIG. 5, the control unit 9 includes a process controller 91 having a CPU, and a user interface 92 and a storage unit 93 that are connected to the process controller 91. The process controller 91 collectively controls the components such as the support part 2, the microwave introduction mechanism 3, the gas inlet part 5, the exhaust system 7, and the like. Further, the user interface 92 includes a keyboard or a touch panel for allowing an operator to perform an input operation of commands to manage the microwave irradiation apparatus 100, a display for visually displaying an operational status of the microwave irradiation apparatus 100 and the like. The storage unit 93 stores a control program (software) for implementing a process executed by the microwave irradiation apparatus 100 under the control of the process controller 91, a process recipe in which processing condition data and the like are recorded, and the like. The control program and the process recipe are stored in a storage medium of the storage unit 93 to be readable by a computer. The storage medium may be a hard disk or a portable storage medium such as a CD-ROM, flash memory, DVD, and Blu-ray disc. Further, the recipe may be transmitted appropriately from another device through, e.g., a dedicated line.

Further, if necessary, any control program or recipe is retrieved from the storage unit 93 in accordance with instructions from the user interface 92 and executed by the process controller 91. Accordingly, a desired process is performed by the microwave irradiation apparatus 100 under the control of the process controller 91.

Further, in the present embodiment, the temperature is monitored by the radiation thermometers 83 of the temperature monitoring unit 81, and the signal is sent from the temperature measuring portion 84 to the process controller 91. Further, the electric field in the processing chamber 1 is monitored by the electric field sensors 85 of the electric field monitoring unit 82, and the signal is sent from the electric field measuring unit 86 to the process controller 91. Based on the monitored electric field value, the process controller 91 controls the power inputted into the processing chamber 1 from the microwave introduction mechanism 3 to optimize the electric field of the wafer W.

<Shape and Arrangement of Microwave Introduction Ports>

(Shape of Microwave Introduction Ports)

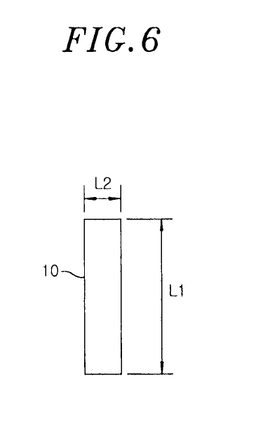

As shown in FIG. 6, each of the four microwave introduction ports 10 has a rectangular shape having long and short sides in its plan view. A ratio L1/L2 of a length L1 of the long side to a length L2 of the short side of the microwave introduction port 10 is, for example, equal to or greater than 2 and equal to or less than 100, and preferably 5 to 20. By forming the microwave introduction ports 10 in a flat shape, the directivity of the microwaves radiated into the processing chamber 2 from the microwave introduction port 10 can be increased in a direction perpendicular to the long sides (direction parallel to the short sides) of the microwave introduction ports 10.

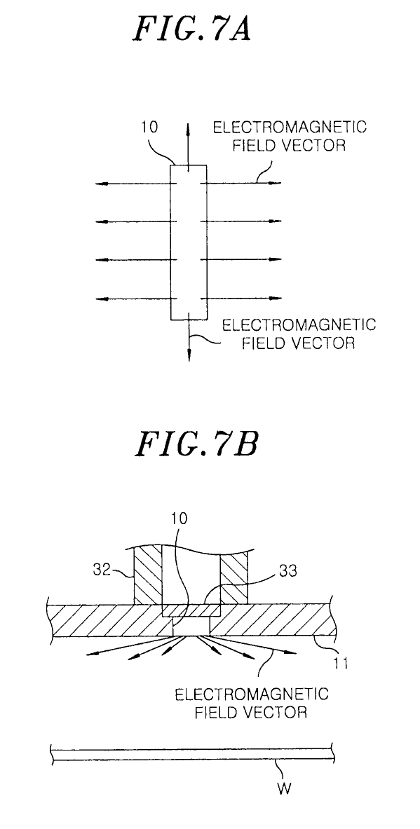

FIGS. 7A and 7B show a state in which the microwaves are radiated from the microwave introduction port 10. FIG. 7A is a bottom view of the microwave introduction port 10, and FIG. 7B is a cross-sectional view of the top wall 11 of the processing chamber 1 taken along the short-side direction of the microwave introduction port 10. In FIGS. 7A and 7B, arrows indicate electromagnetic field vectors radiated from the microwave introduction port 10. As shown in FIGS. 7A and 7B, the microwaves are radiated outwardly from the microwave introduction port 10. When L1/L2 of the microwave introduction port 10 is large, as shown in FIG. 7A, the microwaves have radiation directivity such that the directivity of the microwaves is increased in the direction perpendicular to the long sides.

Further, since the microwave introduction port 10 has a flat shape in this manner, the microwaves are radiated to extend outwardly from the microwave introduction port 10, and the microwaves radiated directly to the wafer W are very few. Further, since a microwave radiation space in which the microwaves are radiated is defined by the top wall 11, the sidewalls 12, and the rectifying plate 16 formed of a metal material; the radiated microwaves are reflected by these components and scattered in the microwave radiation space to be incident on the wafer W.

When the ratio L1/L2 of the length L1 of the long side to the length L2 of the short side is less than 2, the microwaves radiated into the processing chamber 2 through the microwave introduction port 10 is apt to be directed in the direction parallel to the long side (the direction perpendicular to the short side) of the microwave introduction port 10. Further, if the ratio L1/L2 is less than 2, the directivity of the microwaves becomes strong in the direction directly downward of the microwave introduction port 10; therefore, when the gap between the wafer W and the transmission window 33 is short, microwaves are irradiated directly to the wafer W, and localized heating is likely to occur. Meanwhile, if the ratio L1/L2 exceeds 20, since the directivity of the microwaves toward the direction parallel to the long side (the direction perpendicular to the short side) of the microwave introduction port 10 or the direction downward of the microwave introduction port 10 is excessively weak, the heating efficiency of the wafer W may be reduced.

Further, in the length L1 of the long side of the microwave introduction port 10, for example, L1=n̂λq/2 (n is an integer) (where λg is a wavelength in the waveguide 32) is preferable, and n=2 is more preferable.

(First Arrangement Example of Microwave Introduction Ports)

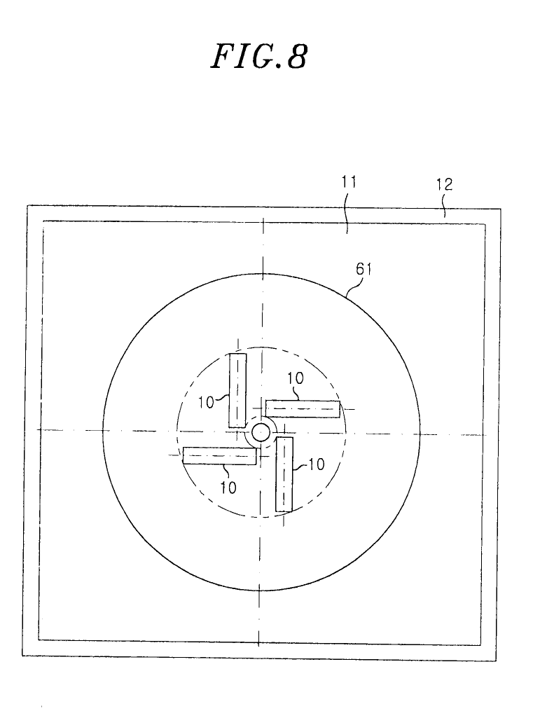

FIG. 8 is a bottom view of the top wall 11 showing a first arrangement example of the microwave introduction ports. As shown in FIG. 8, the four microwave introduction ports 10 are provided in the main body 61 of the upper shower mechanism 52 fitted to the top wall 11. Further, a large number of gas holes are provided in the main body 61, but are omitted in this example. Further, the four microwave introduction ports 10 are disposed uniformly by shifting the orientations of the adjacent microwave introduction ports 10 by 90° such that the longitudinal directions of the adjacent microwave introduction ports 10 are orthogonal to each other. Further, they are arranged such that the longitudinal axes of the microwave introduction ports 10 opposite to each other with respect to the center of the main body 61 do not overlap. The size or L1/L2 of each of the microwave introduction ports 10 may be different, but it is preferable that all of the four microwave introduction ports 10 have the same size and shape in view of improving the controllability and enhancing the uniformity of the heat treatment to the wafer W. Thus, by increasing the value of L1/L2 of the microwave introduction port 10, and arranging the microwave introduction ports 10 such that the orientations of the adjacent microwave introduction ports 1 are shifted by 90° and the longitudinal axes of the microwave introduction ports 10 opposite to each other with respect to the center of the main body 61 do not overlap, it is possible to suppress the loss of power by preventing, as much as possible, the microwaves introduced from each microwave introduction port 10 from entering the other microwave introduction ports 10.

Further, the four microwave introduction ports 10 arc provided such that the long sides and the short sides are parallel to the inner wall surfaces of the four sidewalls 12. Thus, most of the microwaves radiated from one microwave introduction port 10 proceed and propagate in two directions perpendicular to its long side; and when they are reflected respectively by the two sidewalls 12, the directivity (the direction of the electromagnetic field vector) of the reflected wave is opposite to the directivity (the direction of the electromagnetic field vector) of the traveling wave by 180 degrees, and it is hardly scattered in the direction toward the other microwave introduction ports 10. This also makes it possible to suppress the loss of power by preventing the microwaves introduced from each microwave introduction port 10 from entering the other microwave introduction ports 10.

In the example of FIG. 8, since the four microwave introduction ports 10 are evenly disposed, a relatively uniform electric field can be formed in an existence region of the wafer W in the processing chamber 1.

(Second Arrangement Example of Microwave Introduction Ports)

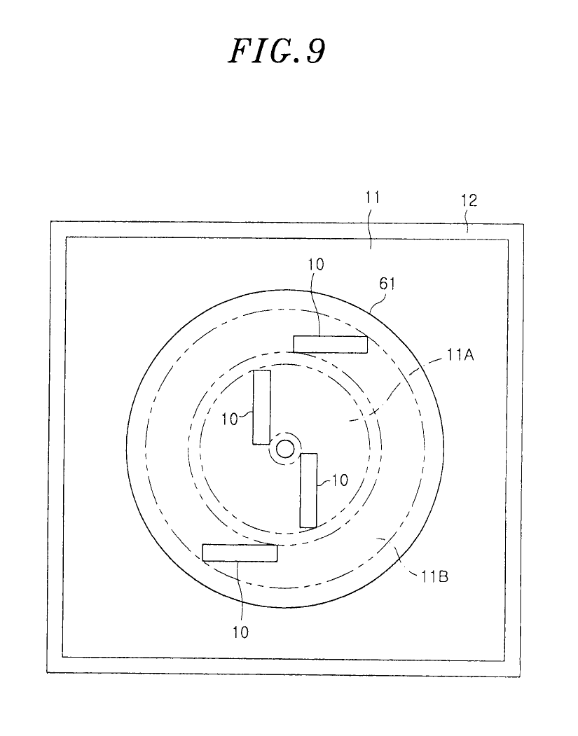

FIG. 9 is a bottom view of the top wall 11 showing a second arrangement example of the microwave introduction ports. In the first arrangement example of FIG. 8, the microwave introduction ports 10 are evenly arranged, but in this example, a portion of the top wall 11 (the main body 61 of the upper shower mechanism 52) corresponding to the wafer W is divided into an inner area 11A corresponding to a central portion of the wafer W and an outer area 11B corresponding to an outer peripheral portion of the wafer W. Further, while maintaining the directions and shapes of the four microwave introduction ports 10 in the same way as in the first arrangement example, one of the groups of the microwave introduction ports 10 that are not adjacent to each other is arranged in the inner area 11A, and the other group is arranged in the outer area 11B.

In the example of FIG. 9, it is possible to control the electric field distribution of the wafer W by independently adjusting a microwave power introduced through the microwave introduction ports 10 formed in the inner area 11A and a microwave power introduced through the microwave introduction ports 10 formed in the outer area 11B.

(Third Arrangement Example of Microwave Introduction Ports)

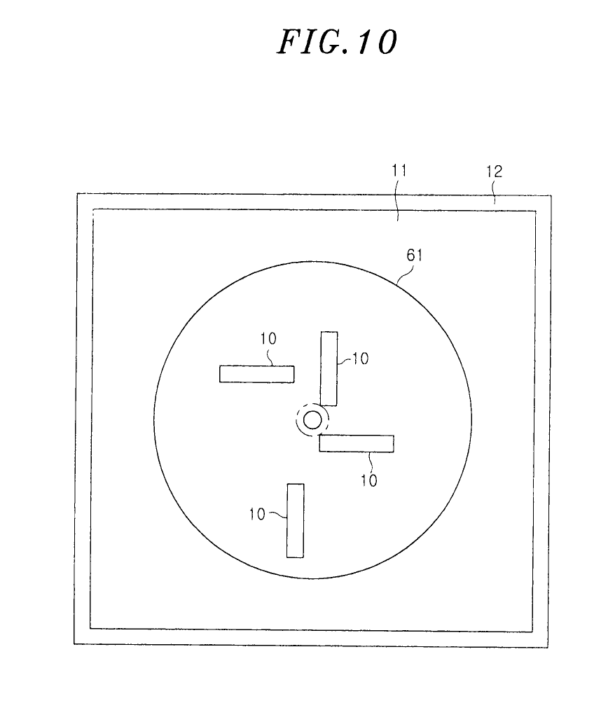

FIG. 10 is a bottom view of the top wall 11 showing a third arrangement example of the microwave introduction ports. In this example, while maintaining the shapes and directions of the four microwave introduction ports 10 in the same manner as in the first arrangement example, the positions of the four microwave introduction ports 10 are shifted appropriately; and it is possible to independently adjust the microwave powers of the microwave units 30 corresponding to the four microwave introduction ports 10, respectively. Thus, it is possible to control the electric field distribution of the wafer W with high accuracy.

<Processing Operation of Microwave Irradiation Apparatus>

Next, there will be described a processing operation in the microwave irradiation apparatus 100 configured as described above.

Prior to processing, a command is given from the user interface 92 to the process controller 91 to perform a specific microwave irradiation process, e.g., impurity activation annealing after implanting impurities into the wafer W in the microwave irradiation apparatus 100, and the process controller 91, in response to this command, reads the process recipe stored in the storage medium of the storage unit 93, and executes the following processing based on the process recipe.

First, while the gate valve G is set in the open state, the wafer W is loaded into the processing chamber 1 through the transfer port 12a by the transfer device (not shown) and placed on the support pins 23. Then, the wafer W is set to a predetermined height position by the elevation drive unit 25. By driving the rotary drive unit 24 at this height position, the wafer W is rotated in a horizontal plane. Further, the rotation of the wafer W may be continuous or non-continuous.

Then, the gate valve G is closed, and if necessary, the processing chamber 1 is evacuated by the exhaust system 7. Then, gases functioning as an atmosphere forming gas, a cooling gas, a purge gas, and the like are introduced into the processing chamber 1 through the upper shower mechanism 52 and the side shower mechanism 53 from the gas supply unit 51 of the gas inlet part 5. The internal space of the processing chamber 1 is adjusted to a predetermined pressure by adjusting the gas supply amount and the gas exhaust amount.

Then, the microwave is generated by applying a voltage to the magnetron 31 of each of the microwave units 30 from the high voltage power supply unit 40. The microwave generated in the magnetron 31 propagates in the waveguide 32, passes through the transmission window 33, and is introduced into a space above the wafer W rotated in the processing chamber 1. In the present embodiment, the microwaves are sequentially generated in the magnetrons 31, and the microwaves are alternately introduced in the processing chamber 1 through the respective microwave introduction ports 10. Further, the microwaves may be simultaneously generated in the magnetrons 31, and the microwaves may be introduced into the processing chamber 1 at the same time through the microwave introduction ports 10.

The microwaves introduced into the processing chamber 1 are irradiated to the surface of the wafer W being rotated, and the wafer W is heated rapidly by electromagnetic heating such as induction heating, magnetic heating, Joule heating, or the like. As a result, the annealing process is performed on the wafer W. During the annealing process, the height position of the wafer W can be displaced in multiple stages of two or more stages. For example, from the start of the annealing process up to a certain period of time, the wafer W is set to a predetermined height position. Then, by driving the elevation drive unit 25, the wafer W is set at a height position different from the initial height position and the remaining annealing is performed. Thus, by processing the wafer W at the height positions of two or more stages, it is possible to reduce variation in the microwave irradiated to the wafer W and to equalize the heating temperature of the surface of the wafer W.

When microwaves are irradiated in this manner, in the monitoring part 8, the temperature is monitored by the temperature monitoring unit 81, and the electric field in the processing chamber is monitored by the electric field monitoring unit 82. In the electric field monitoring unit 82, a signal detected by the electric field sensors 85 is measured as an electric field in the processing chamber 1 by the electric field measuring unit 86. Based on the signal, the microwave power introduced into the processing chamber 1 from the microwave introduction mechanism 3 is controlled.

In a conventional microwave irradiation apparatus, the control of the microwave power by feeding back the temperature or performing open loop control for defining a process with only the processing time and the set microwave power has been generally carried out. However, in the open loop control, a stability problem during mass production occurs, and the reproducibility of the process is not sufficient in the case of controlling the microwave power by feeding back the temperature.

In contrast, in the present embodiment, the electric field in the processing chamber 1 is monitored by the electric field sensors 85, and the microwave power of the microwave introduction mechanism 3 is controlled on the basis of the electric field. Accordingly, it is possible to control the electric field due to microwaves on the wafer W in the processing chamber 1. Therefore, it is possible to stably perform a microwave irradiation process, and improve the stability of mass production and the reproducibility of the process.

Specifically, for example, the value of the electric field detected by the electric field sensors 85 and the value of the electric field on the wafer or the distribution of the electric field on the wafer surface are measured in advance, and the correlation data between them are created and inputted in the process controller 91 or the storage unit 93 of the control unit 9. Further, a relationship between the microwave power introduced from the microwave introduction mechanism 3 and the value of the electric field detected by the electric field sensors 85 is measured in advance and inputted in the process controller 91 or the storage unit 93 of the control unit 9. In the actual processing, the distribution of the electric field on the wafer surface or the value of the electric field on the wafer is estimated from the correlation data, and base on the relationship between the microwave power and the value of the electric field detected by the electric field sensors 85, the microwave power is controlled such that the estimated value of the electric field on the wafer or distribution of the electric field on the wafer surface becomes a desired value.

In the case of the first arrangement example of the microwave introduction ports 10 shown in FIG. 8, since the four microwave introduction ports 10 are uniformly arranged, it is possible to ensure the uniformity of the electric field distribution to some extent. Thus, it is possible to control the microwave power from the microwave introduction mechanism 3 such that the electric field on the wafer becomes a desired value. In this case, in order to adjust the initial electric field distribution, it is possible to set the microwave power ratio of each of the microwave units 30 and control the microwave power from the microwave introduction mechanism 3 such that the electric field on the wafer at the ratio becomes a desired value. Further, based on the data of the electric field sensors 85, a desired uniformity may be obtained by controlling the power of the microwave introduced through each of the microwave introduction ports 10.

On the other hand, in the case of the second arrangement example of the microwave introduction ports 10 shown in FIG. 9, since two microwave introduction ports 10 are provided in the inner area 11A corresponding to the central portion of the wafer W and two microwave introduction ports 10 are provided in the outer area 11B corresponding to the outer portion of the wafer W, it is possible to control the electric field distribution in the wafer surface by adjusting the ratio of the microwave power introduced from the microwave introduction ports 10 provided in the inner area 11A to the microwave power introduced from the microwave introduction ports 10 provided in the outer area 11B.

Specifically, the distribution of the electric field on the wafer surface is estimated on the basis of the detection value of the electric field sensors 85. The total microwave power introduced from the microwave introduction mechanism 3, and the ratio of the microwave power of the two microwave units 30 introducing the microwaves from the two microwave introduction ports in of the inner area 11A to the microwave power of the two microwave units 30 introducing the microwaves from the two microwave introduction ports 10 of the outer area 11B are controlled such that the estimated distribution of the electric field on the wafer surface becomes a desired value.

In the case of the second arrangement example, it is possible to adjust the microwave power to be introduced in the inner area 11A corresponding to the central portion of the wafer W and the outer area 11B corresponding to the outer peripheral portion of the wafer W. Accordingly, it is possible to control the electric field distribution in the wafer surface and increase the uniformity of electric field distribution in the wafer surface. Thus, it is possible to improve the uniformity of the microwave irradiation process.

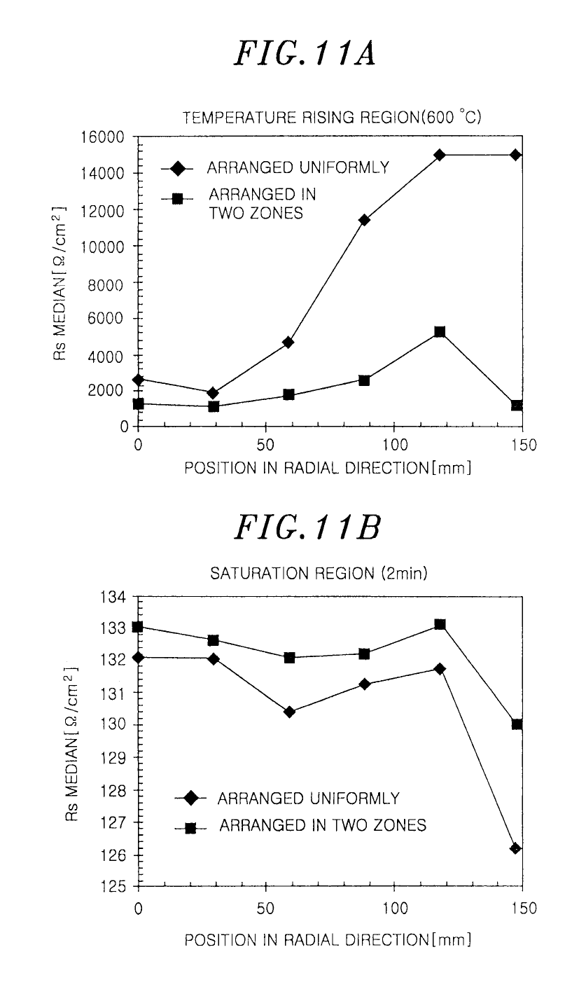

FIGS. 11A and 11B are diagrams showing the results of obtaining the variation in the resistance of the wafer in the radial direction for a temperature rising region (when it reaches 600° C.) (FIG. 11A) and a saturation region (2 min after it reaches 600° C.) (FIG. 11B) when it is subjected to activation treatment at 600° C. by irradiating the microwave to the 300 mm wafer to optimize the microwave power in a case where the microwave introduction ports 10 are uniformly arranged as shown in FIG. 8 and a case where the microwave introduction ports 10 are arranged in two zones as shown in FIG. 9. In the case where the microwave introduction ports 10 are uniformly arranged, the microwave introduction ports 10 are provided in a range of 29 to 84 mm radius from the center of the main body 61 of the upper shower mechanism 52. In the case where the microwave introduction ports 10 are arranged in two zones, the inner area 11A was set to be in a range of 29 to 84 mm radius from the center of the main body 61, and the outer area 11B was set to be in a range of 106 to 138 mm radius from the center of the main body 61. As shown in FIGS. 11A and 11B, by arranging the microwave introduction ports 10 in two zones to control the electric field distribution, it was confirmed that the uniformity of the resistance value increases in both the temperature rising region and the saturation region compared to the case where the microwave introduction ports 10 are uniformly arranged.

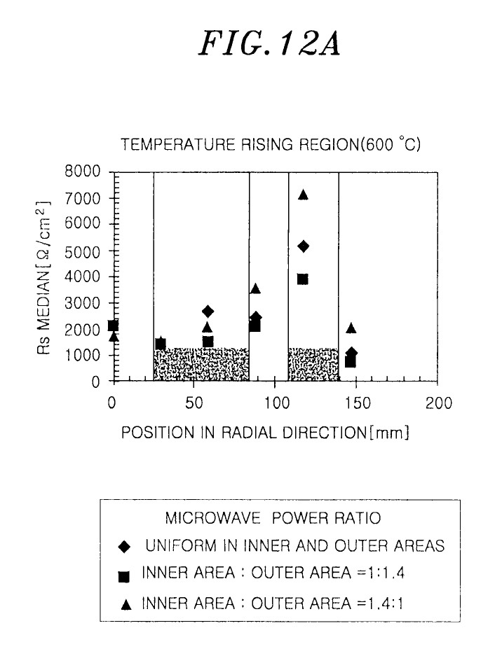

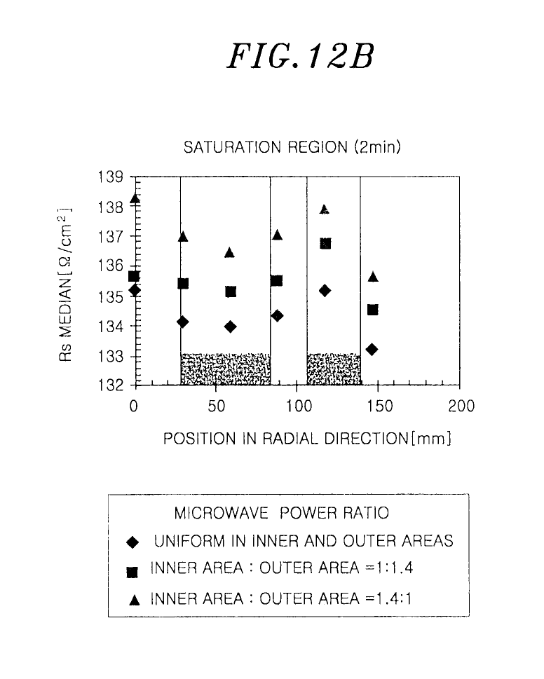

FIGS. 12A and 12B are diagrams showing the results or obtaining the variation in the resistance of the wafer in the radial direction for a temperature rising region (when it reaches 600° C) (FIG. 12A) and a saturation region (2 min after it reaches 600° C) (FIG. 12B) when it is subjected to activation treatment at 600° C by irradiating the microwaves to the wafer while varying the ratio of the power of the microwaves introduced through the microwave introduction ports 10 formed in the inner area 11A to the power of the microwaves introduced through the microwave introduction ports 10 formed in the outer area 11B when the microwave introduction ports 10 are arranged in two zones as shown in FIG. 9. As shown in FIGS. 12A and 12B, it was confirmed that by varying the power ratio of the microwaves introduced in the inner area 11A and the outer area 11B, the distribution of the resistance value has changed in both the temperature rising region and the saturation region, and it is possible to control the uniformity of the microwave irradiation process by adjusting the power ratio of the microwaves. In the case of this example, the uniformity of the process in the wafer surface increases compared to the case of introducing the microwaves uniformly by setting the microwave power introduced into the outer area 11B to be 1.4 times the microwave power introduced into the inner area 11A. Thus, it was confirmed that the controllability increased in the second arrangement example of the microwave introduction ports 10 shown in FIG. 9.

Further, in the example of FIG. 9, the area is divided into two areas, i.e., the inner area 11A and the outer area 11B, and two microwave introduction ports 10 are provided in each area. However, the divided areas are not limited to concentric circle areas, and may be, e.g., left and right areas. Also, the divided areas are not limited to two areas, and it may be divided into four areas and one microwave introduction port 10 may be provided in each area. Further, the electric field sensors 85 may be provided in the respective areas, and a detection value of the electric field in each area may be fed back to the microwave unit 30 corresponding to the microwave introduction port 10 or each area.

In the third arrangement example of the microwave introduction ports 10 shown in FIG. 10, the positions of the four microwave introduction ports 10 are shifted appropriately, and the microwave powers introduced through the four microwave introduction ports 10 can be adjusted independently. Accordingly, by adjusting the power ratio of the microwaves introduced through the four microwave introduction ports 10, it is possible to control the electric field distribution in the wafer surface.

Specifically, the distribution of the electric field on the wafer surface is estimated on the basis of the detection values of the electric field sensors 85, and the microwave power introduced from the microwave introduction mechanism 3, and the ratio of the microwave powers of the microwave units 30 corresponding to the four microwave introduction ports 10 are controlled such that the estimated distribution of the electric field on the wafer surface becomes a desired value.

By this control, the electric field distribution in the wafer surface can be controlled with high precision, thereby further enhancing the uniformity of the microwave irradiation process.

When the positions of the four microwave introduction ports 10 are set appropriately and the microwave powers introduced through the microwave introduction ports 10 are adjusted independently, it is preferable to further increase the directivity of the microwave introduction ports 10. Further, in this case, the electric field sensors 85 are provided corresponding to the four microwave introduction ports 10, and the microwave powers introduced through one corresponding microwave introduction ports 10 are controlled on the basis of the detection values of the electric field sensors 85. Thus, it is possible to more accurately control the electric field distribution.

As described above, after the microwave annealing is performed for a predetermined period of time, the generation of the microwave is stopped by a command from the process controller 91, the rotation of the wafer W is stopped, and the supply of the gas such as the cooling gas or the like is stopped, thereby completing the annealing of the wafer W. Then, if necessary, the gas in the processing chamber 1 is purged, and then, the gate valve G is opened. After the height position of the wafer W on the support pins 23 is adjusted to the height of the transfer port 12a, the wafer W is unloaded by the transfer device (not shown).

<Other Applications>

Further, the present invention may be variously modified within the spirit of the present invention without being limited to the above embodiment. For example, in the above embodiment, an example in which four microwave introduction ports are provided and the number of the microwave units is four has been illustrated, but it is not limited thereto.

Further, in the embodiment described above, an example of mainly applying the microwave irradiation apparatus to the impurity activation annealing has been illustrated, but the present invention is not limited thereto if it is necessary to heat the substrate to be processed. Further, in the embodiment, a case of using a semiconductor wafer as a substrate to be processed has been illustrated, but in the principle of the present invention, the substrate to be processed is not limited to a semiconductor wafer, and it may be applied to the microwave irradiation process for a variety of substrates such as a flat panel display substrate: and a substrate for a solar cell panel.

While the invention has been shown and described with respect to the embodiments, it will be understood by those skilled in the art that various changes and modifications may be made without departing from the scope of the invention as defined in the following claims.

What is claimed is:

1. A microwave irradiation apparatus for performing a predetermined process by irradiating a microwave to a target substrate, comprising:
a processing chamber configured to accommodate the target substrate;
a support member configured to support the target substrate in the processing chamber;
a microwave introduction mechanism configured to generate microwaves and introduce the microwaves into the processing chamber;
one or more microwave introduction ports through which the microwave generated by the microwave introducing mechanism is introduced into the processing chamber;
one or more electric field sensors configured to measure an electric field formed by the microwave introduced into the processing chamber; and
a control unit configured to control powers of the microwaves introduced into the processing chamber through the microwave introduction ports from the microwave introduction mechanism based on the electric field measured by the electric field sensors.

2. The microwave irradiation apparatus of claim 1, wherein the control unit controls the powers of the microwaves introduced through the microwave introduction ports such that an electric field distribution of the target substrate has a desired uniformity based on detection values of the electric field sensors.

3. The microwave irradiation apparatus of claim 1, wherein the electric field sensors are provided at positions corresponding to the microwave introduction ports, respectively.

4. The microwave irradiation apparatus of claim 2, wherein the microwave introduction ports are provided at a top wall of the processing chamber, and in case the top wall is divided into a plurality of areas corresponding to the target substrate, at least one of the microwave introduction ports is provided in each of the areas, and
wherein the control unit controls the power of the microwave introduced through the microwave introduction port of each of the areas such that an electric field distribution of the target substrate has a desired uniformity based on detection values of the electric field sensors.

5. The microwave irradiation apparatus of claim 4, wherein the electric field sensors are provided to correspond to the areas, respectively.

6. The microwave irradiation apparatus of claim 4, wherein the areas have an inner area corresponding to a central portion of the target substrate and an outer area corresponding to an outer peripheral portion of the target substrate.

7. The microwave irradiation apparatus of claim 5, wherein the areas have an inner area corresponding to a central portion of the target substrate and an outer area corresponding to an outer peripheral portion of the target substrate.

8. The microwave irradiation apparatus of claim 6, wherein the microwave introduction ports include four microwave introduction ports, and two microwave introduction ports are provided in each of the inner area and the outer area.

9. The microwave irradiation apparatus of claim 7, wherein the microwave introduction ports include four microwave introduction ports, and two microwave introduction ports are provided in each of the inner area and the outer area.

10. The microwave irradiation apparatus of claim 2, wherein the microwave introduction ports include four microwave introduction ports which are arbitrarily arranged, and the power of the microwave introduced through each of the four microwave introduction ports is controlled independently.

11. The microwave irradiation apparatus of claim 3, wherein the microwave introduction ports include four microwave introduction ports which are arbitrarily arranged, and the power of the microwave introduced through each of the four microwave introduction ports is controlled independently.

12. The microwave irradiation apparatus of claim 1, further comprising a rotation mechanism to rotate the target substrate supported by the support member, wherein the target substrate is rotated when microwaves are irradiated to the target substrate.

13. The microwave irradiation apparatus of claim 2, further comprising a rotation mechanism to rotate the target substrate supported by the support member, wherein the target substrate is rotated when microwaves are irradiated to the target substrate.

14. The microwave irradiation apparatus of claim 3, further comprising a rotation mechanism to rotate the target substrate supported by the support member, wherein the target substrate is rotated when microwaves are irradiator to the target substrate.

15. The microwave irradiation apparatus of claim 4, further comprising a rotation mechanism to rotate the target substrate supported by the support member, wherein the target substrate is rotated when microwaves are irradiated to the target substrate.

16. The microwave irradiation apparatus of claim 5, further comprising a rotation mechanism to rotate the target substrate supported by the support member, wherein the target substrate is rotated when microwaves are irradiated to the target substrate.

17. The microwave irradiation apparatus of claim 6, further comprising a rotation mechanism to rotate the target substrate supported by the support member, wherein the target substrate is rotated when microwaves are irradiated to the target substrate.

18. The microwave irradiation apparatus of claim 7, further comprising a rotation mechanism to rotate the target substrate supported by the support member, wherein the target substrate is rotated when microwaves are irradiated to the target substrate.

19. The microwave irradiation apparatus of claim 3, further comprising a rotation mechanism to rotate the target substrate supported by the support member, wherein the target substrate is rotated when microwaves are irradiated to the target substrate.

20. The microwave irradiation apparatus of claim 9, further comprising a rotation mechanism to rotate the target substrate supported by the support member, wherein the target substrate is rotated when microwaves are irradiated to the target substrate.
